(19) United States
(12) Patent Application Publication
(10) Pub. No.: US 2011/0076357 A1
(43) Pub. Date: Mar. 31, 2011

(54) SINGLE-STAGE BAKED GOODS PRODUCTION

(76) Inventors: Markus Brandt, Minden (DE); Georg Böcker, Minden (DE)

(21) Appl. No.: 12/996,083

(22) PCT Filed: Jun. 2, 2009
(86) PCT No.: PCT/EP09/56764

§ 371 Date: Dec. 3, 2010

(30) Foreign Application Priority Data
Jun. 3, 2008 (EP) 08157488.1

(51) Int. Cl. A21D 8/04; A23L 1/28; A21D 13/00

(52) U.S. Cl. 426/20; 426/62; 426/549; 426/19

(57) ABSTRACT

The present invention relates to a method for producing baked goods from sourdough. The present invention further relates to the composition of a triebferments for improved, accelerated and easier production of sourdoughs, while at the same time maintaining stabile quality, and the baked goods resulting therefrom.

The present invention is in regard to a method for manufacturing baked goods from sourdough. Further the present invention is in regard to the composition of ferment for improved, accelerated and easier, but at the same time quality stabilizing manufacturing of sourdough and the baked goods resulting therefrom.

The mixing of grain flour products and water after a certain fermentation period inevitably leads to a sourdough, which is characterized by its sour flavor, its fermentation aromas and an increase in volume due to microbial gas formation. This so-called grain fermentation is usually caused by simultaneous or consecutive growth of lactic acid bacteria and yeast that are present in the flour. Other groups of microorganisms are inhibited at the start of the fermentation by the anaerobic conditions and the acidification of the dough to pH-values between 3 and 4.

The term lactic acid bacteria is a term with historic origins for a group of bacteria, whose common physiological characteristic is that they form lactic acid as a main product of the carbohydrate metabolism. Lactic acid bacteria are Gram-positive, anaerobic or optionally anaerobic, non-spore forming coccoids or rods. A special characteristic is their limited potential for biosynthesis of cell elements, e.g. vitamins, amino acids, purines and pyrimidines. According to the current taxonomy they are referred to as genus Lactobacillaceae. Because of improved molecular biological methods of taxonomy today there are fifteen more species assigned to genus of lactic acid bacteria, genii Carnobacterium, Enterococcus, Lactobacillus, Lactococcus, Leuconostoc, Oenococcus, Pediococcus, Streptococcus, Tetragenococcus and Weissella that are relevant for food manufacturing belong to these.

Because the quality of all fermented foods depends heavily on the composition of the fermentation flora, the most important species from the family of lactic acid bacteria that are used in sourdough fermentation are listed in the following Table 1.

TABLE 1

| Homofermenting | Heterofermenting | Morphology |
|---|---|---|
| L. salivarius | L. sanfranciscensis | Rods |
| L. mindensis | L. fermentum | Rods |
| L. casei | L. cellobiosus | Rods |
| L. coryniformis | L. brevis | Rods |
| L. curvatus | L. pontis | Rods |
| | L. hammesii | Rods |
| | L. brevis | Rods |
| L. plantarum | L. panis | Rods |
| E. faecalis | Le. paramesenteroides | Coccoids |
| L. coryniformis | L. brevis | Rods |
| L. curvatus | L. pontis | Rods |
| | L. hammesii | Rods |
| | L. brevis | Rods |
| L. plantarum | L. panis | Rods |
| E. faecalis | Le. paramesenteroides | Coccoids |
| Lc. lactis | W. cibaria | Coccoids |
| P. parvulus | | Coccoids |
| P. pentosaceus | | Coccoids |

Lactobacillus sanfranciscensis is a species of lactic acid bacteria that has particularly well adapted to growth in sourdough. It stands out for example because of its ability to acidify very fast and adapt fast to changing environmental conditions. Its efficient maltose metabolism, the ability to use electron acceptors available in sourdough for ATP-formation, as well as a metabolism adapted to the grain substrate aid the dominance of this heterofermenting Lactobacillus, especially in continuously propagated sourdough.

Although a large number of lactic acid bacteria has been isolated from sourdough, still in sourdough there are commonly not more than 1 to 4 different strains of lactic acid bacteria and 1 to 2 different strains of yeast, which can belong to the same or different species. A model to explain this is that microorganisms that are able to adapt quickly to changing environmental condition have a growth advantage.

The different yeast strains occurring in wheat and rye sourdoughs usually account for less than 0.1 to 10% of the total flora. The yeasts most commonly occurring in sourdough are listed in Table 2.

TABLE 2

| Key germs | Common isolates |
|---|---|
| C. humilis | S. pastorianus |
| C. milleri | S. minor |
| S. exiguous | S. fructum |
| S. cerevisiae | C. homii |
| | C. krusei |

Typically yeasts are present in colony counts of up to 9×10⁴ cfu/g in grain and up to 2×10³ cfu/g in flour. They can also be the cause of exhaustive fermentation in sourdough. In grains from Germany one can typically find 14 different yeast species, among them the genii Candida, Cryptococcus, Pichia, Rhodotorula, Trichosporon, Saccharomyces, Sporobolomyces.

It is noted that not all these yeast species are desirable. Trichosporon cutaneum, for example, is a commonly found yeast in grains and their flour products. Spores of this yeast, just like those of Candida zeylanoides and Sporobolomyces salmanicolor, which are found in a smaller number, are potentially human pathogens.

Ripe sourdoughs generally contain between 5×10⁸ and 5×10⁹ cfu/g lactic acid bacteria and between 10³ and 10⁸ cfu/g yeast. When the spore numbers are smaller than 10⁷ lactic acid bacteria and less than 10⁵ yeast/g in ripe sourdough, it cannot be spoken of a relevant contribution of the organisms to the metabolic process.

Bread and other baked goods manufactured with the aid of sourdough stand out due to their special quality. While with rye flour products acidification is required to ensure good bake quality, with wheat the acidification of the dough serves preferentially to achieve an improvement in sense qualities, especially of the aroma, the required fermentation nowadays is achieved via added baker's yeast.

Breads manufactured with the aid of sourdough stand out due to their characteristic aroma, improved longevity and longer microbiological stability. This quality is chiefly influenced by the metabolism of the fermentation flora. The fermentation duration, that is the processing conditions during sourdough manufacturing, also have a decisive influence.

In sourdough manufacturing one distinguishes between spontaneous sourdough and inoculated sourdough.

Spontaneous sourdoughs are manufactured by mixing flour and water without adding “Anstellgut” or starting culture. The micro flora of spontaneous sourdough is first and foremost shaped by the micro flora of the flour and can vary according to kind and origin of the grain product. When spontaneous sourdough manufactured from flour and water is used as “Anstellgut” for a propagating sourdough, a characteristic fermentation flora emerges after a few propagation stages, which is typical for the respective propagation parameters and is independent of the micro flora of the grain.

The study of the characteristic flora development in spontaneous sourdoughs has long been scientifically documented. Hochstrasser et al. (1993, mitt. Gebiete Lebensm. Hyg. 84: 356-381) documents and reports for example on the spore numbers of enterobacteria and lactic acid bacteria in flour that are at first below 10³ cfu/g, as well as on their changes during the sourdough propagation. It was shown hereby that after the first cycle the fermentation flora is mainly dominated by enterobacteria. Already after one more cycle the spore number of the lactic acid bacteria was a factor of 100 larger than that of the enterobacteria, since the latter are inhibited by the low pH values. After four stages the total spore number is practically identical to the spore number of the lactic acid bacteria, in addition a yeast population forms increasingly.

It is important in the relation with spontaneous sourdough to emphasize the necessity of sourdough propagation with several stages, since it strongly influences the composition of the micro flora in the dough. It should be noted that with a too short of a propagation or direct propagation the risk of a contamination with enterobacteria exists. Also, with too short of propagation there is not enough yeast present in the dough to achieve the desired increase in volume and thus in amount of dough. Further, the flavor development due to metabolic products of the lactic acid bacteria is also still poor.

Another disadvantage of spontaneous sourdough is the fact that the micro flora composition in spontaneous sour dough strongly depends on the micro flora of the raw ingredients and their contamination stages. Thus one should count on considerably larger variations and in particular quality variations in baked goods manufactured from spontaneous sourdough.

To influence this micro flora, sourdough—in contrast to spontaneous sourdough—is inoculated with a starter culture or “Anstellgut”. Using “Anstellgut” can help avoid exhaustive fermentation and when the micro flora is kept constant a standardized bread quality can be achieved.

Because the spore numbers of lactic acid bacteria and yeast in “Anstellgut” are roughly 10 to 1000 times higher than the spore numbers in the raw ingredients, the concentration of spores in the flour is practically irrelevant for the development of the micro flora.

In the context of manufacturing of inoculated sourdough one distinguishes next between direct and indirect dough propagation.

One in general understands indirect dough propagation to mean processing conditions for traditional sourdough propagation in at least 3, if desired up to 9 stages. It is critical with indirect propagation that a systematic growth or systematic use of microorganisms take place in preliminary stages. Common names for these stages as well as typical processing conditions are listed in Table 3, using rye as an example.

TABLE 3

| | Stage 1 - early | | |
|---|---|---|---|
| | sour | Stage 2 - basic sour | Stage 3 - full sour |
| Ripening time | 5-8 hrs | 6-10 hrs | 3-10 hrs |
| Temperature | 25-26° C. | 23-28° C. | 25-32° C. |
| Process | Yeast growth | Acid and aroma | Optimization of |
| | | formation | fermentation and |
| | | | acidification |

Next, these stages are listed in Table 4, using wheat sourdough as an example, for example for panettone manufacturing. Traditional panettone manufacturing is propagated in 2 to 3 more complicated stages to a full panettone.

TABLE 4

| | Stage 1 | Stage 2 | Stage 3 |
|---|---|---|---|
| Ripening time | 2-8 hrs | 2-8 hrs | 2-8 hrs |
| Temperature | 18-23° C. | 18-23° C. | 22-28° C. |
| Process | Yeast growth | Yeast growth and | Optimization of |
| | | aroma formation | fermentation and |
| | | | acidification |

Next, the stages for baguette manufacture are listed in Table 5, whereby as is generally known this manufacturing process is one of the most involved bread manufacturing processes with its 3 to 9 stages.

TABLE 5

| | Stage 1 | Stage 2 | Stage 3 | Stage 4 | Stage 5 |
|---|---|---|---|---|---|
| Ripening | 10-16 hrs | 20-26 hrs | 16-20 hrs | 8-12 hrs | 10-14 hrs |
| time | | | | | |
| Temperature | 24-26° C. | 14-16° C. | 14-16° C. | 14-16° C. | 14-16° C. |

The respective ripening times and temperatures listed in the tables above can vary depending on the amount ratios of the ingredients as well as depending on the used starter cultures.

Independent of the particular processing parameters it can be seen that the indirect dough propagation is involved and very time intensive.

The so-called direct propagation dispenses with a growth process with several stages and differs chiefly from the indirect propagation due to the fact that the microbial metabolism is practically almost completely due to the large number of spores in added baker's yeast.

When one compares the direct and indirect propagation, it is judged as a disadvantage of the indirect propagation that this propagation process with several stages is very time intensive and requires manual skill. At the same time the speed and easy handling is to be seen as an advantage of the direct propagation. Such direct propagated and baker's yeast containing dough stands out due to its good fermentation and the ability to be easily standardized. However, the baked goods made from direct propagating dough or from baker's yeast containing dough the typical and desired aroma. Further such dough only has a medium shelf life.

One speaks with regard to traditional and industrial baking processes of three sourdough types.

Type I sourdough is manufactured using traditional methods and stands out due to the fact that a continuous, often daily propagation (Feeding) is required to keep the micro organisms in an active metabolic state. The fermentation process for Type I sourdough commonly has at least three stages and is usually conducted at temperatures below 30° C.

Type II sourdough is less involved and stands out due to a single-level fermentation process that lasts up to 5 days. The fermentation process of Type II sourdough is commonly conducted at temperatures above 30° C. In Type II sourdough most microorganisms have a limited metabolism. This type II sourdough is mostly used in industrial processes and serves to enhance the flavor and for acidification; it develops too little leavening power to be used on its own.

One understands type III sourdough to mean dried fermentation products that are chiefly used as flavor enhancers and for acidification. It, too, has too little leavening power to be used on its own and without addition of baker's yeast.

Thus, the task of this invention is to provide a shortened and improved process for sour dough manufacturing in order to combine the advantages of indirectly propagated dough, which is good aroma, improved shelf life, with the advantages of directly propagated dough, namely fast and simple handling.

One should especially turn their attention to the fact that the invention avoids and rejects the use of baker's yeast in the way it is implemented in the direct propagation, because the desired aroma improvement in the baked goods is chiefly achieved through and influenced by the metabolism of the microorganisms. It is important in this context to define that in the frame of this invention the term “baker's yeast”, which is also known as “Baeckerhefe”, refers to such strains of Saccharomyces cerevisiae that are specifically cultured for use in dough manufacturing. For that purpose S. cerevisiae is cultured on molasses and under addition of nutrient salts. The composition of the culture medium in yeast manufacturing is of decisive importance for the metabolic features of the produced yeast; this is explained below in more detail.

Glucose is the carbohydrate source of choice for most organisms, since it can be directly included in glycolysis, thus it is the most efficient source with respect to energy yield. Accordingly, other carbohydrate sources like galactose, maltose, sucrose are only used when no glucose is available in the medium. To achieve such a selective behavior in the choice of source of nutrition certain adaptations are necessary that achieve that a series of preferences emerges regarding the degradation of available sources of nutrition. Yeast ferment for example sugars in the following order: glucose, sucrose, maltose. Potential stages of this control system are intake and/or the subsequent metabolic pathways.

Carbohydrates fermented by yeast (glucose, fructose, sucrose and maltose) are taken up from the surrounding medium via different pathways.

In the process the hexose types glucose and fructose are taken up with the help of various transporters via enhanced diffusion. Sucrose is cleaved by invertase in the periplasmatic region, that is outside the cell, into the monosaccharides glucose and fructose, and is then taken up in this form via the corresponding transporters. Maltose is taken up with the aid of an energy dependent proton symporter, the maltose permease, and cleaved inside the cell by maltase, a hydrolase, into two glucose molecules, which are then included in glycolysis and are so metabolized to release energy.

Thus basically, there exist transport systems for glucose and fructose as well as for maltose.

Long term an adaptation of cells to the different sugar sources is achieved by blocking the transcription of the coding gene, a phenomenon that is commonly known as glucose repression. Interestingly, glucose functions in this system, besides its role as the carbon source of choice, also as a signaling molecule for the regulation of the alternative transport and metabolic pathways that utilize other carbon sources. When glucose is used up the gene expression for utilizing other carbon sources is at first derepressed, in some cases it is also induced by alternative sources of nutrition.

The processes of transcription and translation are relatively involved and time intensive and are thus more appropriate for longer term adaptation of the cell to the given nutritional conditions. In contrast, a faster change of the metabolism as a direct adaptation to changing environmental conditions requires a direct influence on the activity of already formed enzymes. Here, too, there are several mechanisms described that are at play in the carbon metabolism in yeast.

Catabolite inactivation is a further cell adaptation to the changes in carbon sources available for growth. Hereby enzymes of the less preferred metabolic pathway are inactivated or even fully degraded through posttranslational modifications, when cells switch to glucose medium.

Catabolite inactivation is also part of the degradation of disaccharides, such as maltose. It has been shown that the maltose transporter degrades proteolytically after adding glucose to the medium. Adding glucose to maltose fermenting yeast leads to a fast and irreversible loss of the ability to transport maltose. This occurs on one hand because of transcription repression of the gene for the maltose permease, on the other hand because of inactivation of the maltose permease, which is the transporter; this effect is referred to in the literature as glucose induced inactivation or catabolitic inactivation (Medintz et al, 1996). Maltose transport can only be recovered via de-novo synthesis of the transporter when maltose induced conditions are present; thus this is an energy and time intensive process.

Glucose detection occurs in case of yeast both inside and outside the cell. In the latter case through homologues of the glucose transporter. Extracellular detection is especially important, since as a consequence glucose, formed through the extracellular cleaving of sucrose by invertase, is detected and leads to a negative feedback to the maltose transporter.

Molasses consists mostly of a mixture of sucrose and invert sugar, that is an equimolar mixture of fructose and glucose. This composition of carbohydrates has great consequences when molasses is used as a component of the nutrient medium for yeast culturing. For example, glucose that is directly contained in molasses as well as glucose generated in the extracellular degradation of sucrose leads to inactivation and the protolytic degradation of the maltose permease as well as to a long term inhibition of the transcription of the gene for the maltose permease. One of the consequence of this is the ability of yeast to take up maltose, and thus a loss of the ability to take up maltose as a carbohydrate.

In the context of the present invention this characteristic of the yeast metabolism, namely the inhibition and repression of the maltose uptake through the presence of glucose as well as indirectly through the presence of sucrose, is of great importance.

Part of the starch that is present in flour is cleaved by amylase, that is, it is taken apart into smaller carbohydrates. In this context E1-amylase is especially important, as it cleaves off disaccharides, e.g. maltose, from the polysaccharide chains. Amylases are present to an extent in grains, as well, and thus in flour. Thus, maltose is the naturally present sugar in flour.

Baker's yeast, or yeast grown on molasses, display great disadvantages in growth on maltose containing nutrient media, due to the mechanisms detailed above.

In baker's yeast, that is yeast that is grown in molasses containing medium, the ability to take up maltose, as shown above, and the following maltose specific metabolic pathways are inhibited. Maltose contained in flour cannot be utilized by yeast. This has consequences for the growth behavior of yeast. Changing of the sugar transport system and the metabolism of the yeast is a long terra process requiring much energy, as this has to occur through the de-novo synthesis of the appropriate enzymatic pathway. It follows that it takes time until the yeast has adapted to using maltose as a carbon source. As a consequence in dough preparation, on one hand, much longer fermentation times are necessary. On another hand, the delayed entrance into the exponential growth phase of yeast has a selection advantage for other organisms contained in the dough, because under certain circumstances they do not require such an adaptation in their metabolism. This is especially noticeable in case of sourdough. Here a deceleration in yeast growth can lead to a completely modified composition of spores and thus to a change in aromatic composition due to the various metabolic products of the different micro organisms and their amount ratios.

A deceleration in yeast growth can be avoided by adding glucose or sucrose to the dough. This can maintain a shorter fermentation period and a particular ratio between lactic acid bacteria and yeast, but in return one would have to do without the typical aroma resulting from the metabolism of maltose in yeast, whereby the aroma is partially also directly due to the degradation and thus loss of maltose.

The maltose content of baked goods is, beside its influence on the aroma, also decisive for further characteristics of the baked goods. For example, rising maltose values cause humid pastry crumbs, and high maltose values cause a loss of elasticity in crumbs, to which a rapid weakening of the crust can be attributed.

There is another problem, because of the assumption that the typical baker's yeasts are unable to change and adapt their metabolism. Pure cultured yeast is used in baker's yeast manufacture, which has been sometimes gained for centuries through culturing and selection. The main focus in growing yeast like this is high leavening power and a small amount of enzymes that destroy gluten. These pure cultured lines are always cultured in molasses containing medium, which means it is not necessary to keep up the alternative carbohydrate and metabolic pathway. The corresponding selection mechanism does not exist; thus it is possible that this alternative pathway has been lost in at least some of the cultured yeast lines. For all these reasons the present invention operates without the addition of baker's yeast or “Baeckerhefe”, that is yeast that has been cultured on molasses.

Aside from the fact that the yeast culturing process is complicated, the metabolic adaptation of yeast grown on molasses makes it difficult for bakers to regenerate large volumes of yeast lines and this in turn causes a severe dependency as well as a large cost factor.

By using the leavening ferment and the process of the present invention the baker can dispense with the addition of baker's yeast, thereby making large savings. Further, the baker is independent of the availability of fresh and ready for use baker's yeast.

It is of decisive importance for the leavening ferment according to this invention that the used yeast was not grown in glucose and/or sucrose containing medium, such as for example medium based on molasses, but instead in medium based on flour.

Characteristics that distinguish the yeast according to this invention and baker's yeast are for one the presence of enzymes that take part in the metabolism of maltose, maltose permease and maltase. Also, the inventors were able to show that baker's yeast has 3 times more total protein compared to yeast according to this invention. Typically, the yeast according to this invention has a total protein amount of 4-6 g/100 g, while baker's yeast has a total protein amount of roughly 15 g/100 g.

The use of yeast relevant to this invention can be assured by the fact that the yeast metabolism is adapted to the sources of carbon available in flour, the yeast can thus immediately enter the exponential growth phase and, therefore, at greatest growth exhibits highest fermentation rate. It should be taken into account, however, that because of the additional required enzymatic steps the growth rate lags that of yeast growing on glucose. Therefore the growth rates and therefore the leavening power of yeast adapted to maltose are clearly different from those of baker's yeast. This in turn influences the required fermentation times in dough manufacturing and in this context, as described above, also the kinetics of the spore number ratios of the micro organisms that take part in fermentation and therefore naturally also the resulting composition of aromatic materials.

The present invention provides in its most general form a new composition of leavening ferment as well as a method for manufacturing sourdough and baked goods free of baker's yeast.

The leavening ferment contains a mixture of at least two or more cultured pure strains of lactic acid bacteria, whereby at least one of the cultured pure strains is a strain from the genus Pediococcus and/or Weissella. Further, the leavening ferment contains at least one cultured strain of yeast. According to the present invention the leavening ferment contains no baker's yeast and/or no yeast strain cultured on molasses.

The cultured pure strains contained in the leavening ferment are chosen from the group of lactic acid bacteria, which for example contains the strains L. plantarum, L. pontis, L. sanfranciscensis, L. crispatus, L. suntoryeus, Le. argentinum, L. helveticus, L. paralimentarius, L. fermentum, L. paracasei, L. frumenti, L. alimentarius, W. cibaria, W. confusa, P. acidilactici, P. parvulus and P. pentosaceus. According to the present invention a concentration of lactic acid bacteria spores of 1×10⁷ to 2×10⁹ cfu/g is desirable.

The leavening ferment according to our attention also notably contains at least one Pediococcus or Weissella strain. The strains contained in the leavening ferment are chosen from the group containing P. acidilactici, P. parvulus, P. pentosaceus, W. cibaria and W. confusa.

The addition of pure strains of Pediococcus and/or Weissella is very unusual, since Pediococcus and Weissella have so far been seen as contaminants and thus as inappropriate for the dough fermentation. According to an implementation example, the leavening ferment contains 1×10⁶ to 3×10⁹ cfu/g of a Pediococcus or Weissella strain with respect to the total spore number of micro organisms in the dry mass of the leavening ferment.

Pediococcus are homofermenting and increase the acid concentration comparatively slowly and only mildly. Surprisingly, we have been able to show in this invention that in a short, direct dough propagation according to the method according to the present invention the mild acidification through Pediococcus and also Weissella strains, which offer an ideal CO₂ product rate, is sufficient to enable an excellent dough preparation.

The invention could therefore show that, surprisingly, the addition of Pediococcus and Weissella to the leavening ferment offers an unexpectedly short and thus single-level dough formation and that the resulting sourdough has a good leavening power, an ideal (namely mild) acidity and a good or mild aroma.

The leavening ferment according to the present invention can reduce the time to manufacture a ripe sourdough to a single stage of at least 5 hours, in other implementation examples 8 hours, in other implementation examples 10 hours, in other implementation examples 12 to 14 hours.

Further, the leavening ferment of the present invention contains at least one cultured yeast strain, chosen from the group consisting of C. humilis, C. milleri, S. exiguous, T. delbrueckii, S. minor, S. pastorianus, S. cerevisiae and S. fructuum, whereby the strains listed here have never been cultured or grown on molasses, since culturing on molasses leads to changes in the metabolic pathways and thus to strain characteristics that govern the flavor. According to our invention a spore concentration of yeast in the leavening ferment of 1×10⁵ to 5×10⁸ cfu/g is desirable.

Further, the choice according to the present invention prefers such strains of the listed yeasts that have adapted to the acidic environment and are therefore not suppressed by acid during the sourdough fermentation. The expert is familiar with many such strains, if need be, however, such strains, when yeast is cultured on grains, cannot be cultured on molasses. This grain culture takes longer but results in yeast that has adapted its metabolism to metabolize maltose instead of sucrose, at the same time, in such grain cultures yeast grow preferably that are adapted to acids such as lactic acid and acetic acid, which are formed during the culturing on grain. They are therefore termed “acid adapted”.

The leavening ferment of the present invention makes it thereby possible to manufacture a sponge dough or sourdough in direct propagation, which exhibits 0.5% lactic acid, preferably 0.3% and at most 1% after an incubation period of 3 to 12 hours, at a temperature between 16° C. and 30° C.

Under the terms of a different implementation example, the present invention therefore also offers a method for an improved direct sourdough propagation.

Direct propagation means in the context of this invention that flour, water and leavening ferment are mixed in a first step, whereby this mixture incubates for 3 to 24 hours, preferably 3 to 6 hours, further preferably 4 to 8 hours, further preferably 4 to 12 hours, further preferably 6 to 18 hours, and further preferably 5 to 24 hours.

The incubation temperature is between 15° C. and 30° C., preferably between 15° C. and 20° C., further preferably between 18° C. and 22° C., further preferably between 18° C. and 24° C., further preferably between 18° C. and 26° C., further preferably between 20° C. and 24° C., further preferably between 21° C. and 26° C. According to the situation the temperature can be increased or decreased.

After the single-stage dough fermentation further baking ingredients are or can be added to the dough, for example sugar, flour, eggs, almonds, fruit and/or flavoring. Addition of leavening agents such as baker's yeast or baking powder is unnecessary and is rejected.

The process according to the present invention stipulates that the baked good can be baked after a dormant or fermenting phase of 0.5 to 6 hours, further preferably 1 to 4 hours, further preferably 1 to 3 hours.

It is critical for the evaluation of the quality of the baked good that has been prepared according to the present invention that the baked good has a lactic acid content of 0.5%, preferably 0.4%, further preferably 0.3% and at most 1.0%.

The content of lactic acid in the dough before the baking or in the finished baked good can be determined via HPLC, which is well known to the expert.

A further parameter for determining the dough quality is the fermentation quotient, which gives the molar ratio of lactic acid to acetic acid. Acetic acid has a much bigger influence on the smell, flavor and shelf life of the baked goods than lactic acid. Thus, a goal of this invention is to influence the fermentation quotient by choosing and adding heterofermenting lactic acid bacteria to the leavening ferment, such that according to one implementation example for rye sourdough made with the leavening ferment of the present invention, that is using the process of the present invention, the fermentation quotient is 1.7 to 2.8, preferably 2.3 to 3.0, further preferably 2.5 to 3.0, and further preferably 3.0 to 3.5, after an incubation period of at least 5 hours, preferably 9, preferably 10, preferably 12 hours and at most 16 hours.

Following another implementation example wheat sponge dough or wheat sourdough is made using the process of the present invention, that is using the leavening ferment of the present invention, whereby the incubation time is at least 5 hours, preferably 9, preferably 10, preferably 12 hours and at most 16 hour. The fermentation quotient is 1.5 to 10, preferably 2.3 to 3.0, further preferably 2.5 to 3.5, further preferably 3.0 to 4.0, further preferably 3.8 to 5.0, further preferably 4.0 to 6.0, further preferably 5.5 to 7.0, further preferably 6.0 to 8.0, further preferably 6.5 to 9.0, further preferably 7.0 to 9.5, and further preferably 7.8 to 10. This fermentation quotient strongly improves the quality of the baked goods and achieves an improved, fine and mildly acidic bread flavor. The fermentation quotient is usually determined as a ratio of the amounts of lactic acid and acetic acid present in the dough, using HPLC.

The ability to degrade material through the leavening ferment is characterized by the increase in the readily available amino acids, which then contribute to the flavor development through formation of sugar esters, but also through the natural degradation to unwanted substances and aldehydes.

Following another implementation example a wheat sponge dough or wheat sourdough is made

in accordance with the process of the present invention, that is while using the leavening ferment of this invention, whereby the incubation time is at least 5 hours, preferably 8, preferably 10, preferably 12 hours and at most 16 hours, the leucine content is 0.1-6 mg/kg of dough, preferably 0.5-4 mg/kg, further preferably 0.5-2 mg/kg, isoleucine content is 0.1-5 mg/kg dough, preferably 0.5-3 mg/kg, further preferably 0.5-1.5 mg/kg, methionine content is 0.1-6 mg/kg dough, preferably 0.5-4 mg/kg, further preferably 0.5-2 mg/kg, valine content is 0.1-6 mg/kg dough, preferably 0.2-4 mg/kg, further preferably 0.3-2 mg/kg and/or phenylalanine content is 0.1-4 mg/kg dough, preferably 0.5-2 mg/kg, further preferably 0.5-1.5 mg/kg, further preferably 0.6-1 mg/kg. The content of amino acid can also be determined via the known HPLC technique.

The process of the present invention, that is, the use of the leavening ferment of the present invention for manufacturing sponge dough or sourdough has an excellent leavening power. This leavening power is, among others, due to the CO₂ manufacturing rate of the micro organisms in the dough. Following another implementation example wheat sponge dough or wheat sourdough is made—in accordance with the process according to this invention, that is while using the leavening ferment of the present invention, whereby the incubation time is at least 5 hours, preferably 9, preferably 10, preferably 12 hours and at most 16 hour, whereby the CO₂ manufacturing rate is 70 to 300 ml/100 g flour, preferably 70 to 150, further preferably 120 to 250 ml/100 g flour.

To determine the CO₂ manufacturing rate the formed gas is extracted from the dough and volumetrically measured by eliminating a saturated table salt solution according to AACC method 10-12.

The process of the present invention, that is, the use of the leavening ferment of the invention for manufacturing sponge dough or sourdough requires less time and gives in direct propagation an excellent baked good or bread, which is chiefly characterized by its fine, mildly sour flavor. This flavor can be quantified for example and according to another implementation example by the content of vanillin in the crust of the baked bread, which is larger than 1000 μg/kg, preferably larger than 1500 μg/kg, further preferably larger than 2000 μg/kg, further preferably larger than 2500 μg/kg dry mass.

The leavening ferment according to the present invention and process is suitable for manufacturing of rye sourdough, but especially so for manufacturing of wheat sourdough and the resulting baked goods. The choice of the micro organisms and the process according to the present invention achieve an intense aroma and mild acidification of the dough.

At the same time the choice of the micro organisms together with the process according to the present invention ensure that the micro flora and the ratio of lactic acid bacteria and yeast, that is the yeast that are adapted to the acid, remain stable in the dough. This enables one to use the formed sourdough or wheat sourdough over several days as “Anstellgut” for new sourdough, without affecting negatively the bread quality and the micro flora of the dough or the leavening power of the dough. Ideally and to avoid changes in the quality a new dough with fresh leavening ferment is nonetheless started once a week.

According to another implementation example, baked goods and especially breads such as wheat breads that have been made from the leavening ferment according to the present invention, have an easily determined and characteristic maltose content of 0.3 to 1.8%, preferably 0.7 to 1.5%, further preferably 0.5 to 1.2%.

In comparison, breads that contain baker's yeast have roughly 2.5% maltose. The amount of maltose can be compared using the expertly known HPLC technology.

The invention is further explained in more detail using a few examples that are not limiting and only serve as suggestions for the expert.

### EXAMPLES

### 1. Composition of Leavening Ferments Suitable for Sourdough in Single-Step Propagation

For the composition of leavening ferments for wheat sourdoughs the following amounts of micro organisms listed in Table 6 are mixed together. The mixture is then divided into portions of 10⁷-10⁹ cfu/g.

TABLE 6

| | Micro organism | cfu/g |
|---|---|---|
| Leavening ferment A | L. crispatus | ca 1 × 10⁸ |
| | L. pontis | ca 1 × 10⁸ |
| | L. plantarum | ca 1 × 10⁸ |
| | L. sanfranciscensis | ca 1 × 10⁸ |
| | L. cerevisiae | ca 1 × 10⁸ |
| Leavening ferment B | P. pentosaceus | ca 1 × 10⁹ |
| | W. cibaria | ca 1 × 10⁸ |
| | W. confusa | ca 1 × 10⁸ |
| | S. cerevisiae | ca 1 × 10⁷ |
| Leavening ferment C | L. plantarum | ca 1 × 10⁸ |
| | L. frumenti | ca 1 × 10⁷ |
| | L. paracasei | ca 1 × 10⁷ |
| | Le. argentinum | ca 1 × 10⁸ |
| | L. helveticus | ca 1 × 10⁷ |
| | L. paralimentarius | ca 1 × 10⁷ |
| | L. fermentum | ca 1 × 10⁸ |
| | S. pastorianus | ca 1 × 10⁷ |
| | P. pentosaceus | ca 1 × 10⁷ |
| Leavening ferment D | L. sanfranciscensis | ca 1 × 10⁹ |
| | C. humilis | ca 1 × 10⁷ |
| | L. suntoryeus | ca 1 × 10⁸ |
| | L. pontis | ca 1 × 10⁸ |
| | L. crispatus | ca 1 × 10⁸ |
| | S. cerevisiae | ca 1 × 10⁷ |

### 2. Single-Stage Sponge Dough Propagation with Leavening Ferment A or B

For the preparation of wheat sponge dough 30 kg leavening ferment is mixed together with 30 kg wheat flour (type 550) and 30 l water. The starting temperature of the mixture should be 22-24° C. The starting mix has a lot of fermentation, so it should be noted that the containers that contain the mixture have at least twice as much fermentation volume. After a resting period of at least 8 hours at room temperature the sponge dough is finished and can be processed further or stored at 4-8° C. Further processing should happen within 8-24 hours. If desired, part of the sponge dough can be used as “Anstellgut” for the next day. It is desirable to take off 30 kg “Anstellgut”. The “Anstellgut” is stored at 4-8° C. for further processing.

For baking without yeast one should ferment 30-40% of the flour. Thus it is recommended for a dough recipe for a total of 100 kg to begin with 70 kg wheat flour (type 550) and 60 kg wheat sponge dough, according to the growth step detailed above.

Alternatively, a dough recipe can be prepared with 40% fermented flour to reach a total flour mass of 100 kg. In this case we mix 60 kg wheat flour (type 550) and 80 kg wheat sponge dough, as explained above in the starting conditions. The ideal temperature is 26-28° C. The dough rests or ferments for 1-1.5 hours, and if need be for 3 hours, before baking.

### 3. Single-Stage Sponge Dough Propagation for Manufacturing Wheat Mixed Bread Using Leavening Ferment A or B

For a total flour mass of 10 kg first 2.8 kg leavening ferment A or B is mixed together with 2.8 kg wheat flour (type 550) and roughly 2.8 l water to achieve sponge dough. The dough temperature should be 18-24° C. The sponge dough is ready after roughly 6 hours and “Anstellgut” can be taken off, if so desired, which should then be stored in a cool environment until further use. The dough should be used for further processing within 36 hours.

For the bread dough 5.6 kg sponge dough and 4.2 kg wheat flour (type 550) and 3 kg rye flour are mixed together, as well as 4 l water and 0.2 kg salt. Ideally, one kneads the dough in a spiral kneader for 3+3 minutes. The dough temperature should be 23-28° C. After a resting period of 60 minutes at 32° C. the dough is separated into pieces of 750 g each and baked after 80-90 minutes fermentation at 32° C. for 40-50 minutes at a temperature decreasing from 250° C. to 210° C.

### 4. Single-Stage Sponge Dough Propagation for Baguette without Baker's Yeast with Leavening Ferment A or B

For a total flour mass of 10 kg first 3 kg leavening ferment A or B is mixed together with 3 kg wheat flour (type 550) and roughly 3 l water. The dough temperature should be 20-26° C. “Anstellgut” can be taken off after 6 hours, which should then be stored at 4-8° C. until further use. The ripe sponge dough is to be stored for roughly 8 hours in a cool environment, then processed within 36 hours. For the baguette dough 6 kg sponge dough, 7 kg wheat flour, 3.2 l water and 0.2 kg salt are mixed together. Ideally one kneads the dough in a spiral kneader for 3+3 minutes. The dough temperature should be 20-24° C. The dough should be processed carefully to achieve the typical pore size. The fermentation occurs outside the fermentation room, sine the air there is too humid and the temperature too high. The dough rests for 60 minutes and is then kneaded again after 30 minutes. The dough is separated into pieces of 300 g and shaped. To lend the dough more stability it rests for another 10 minutes. Afterwards it is rolled into baguette shape using thin rollers and wrap in cloth. The dough ferments for 90 minutes. The dough is then placed onto extractors and cut with a sharp razor/knife. The small pieces of dough are baked in a preheated oven for roughly 30-35 minutes at 230° C.

### 5. Single-Stage Sponge Dough Propagation with Leavening Ferment A or B for Panettone

For a total flour mass of 10 kg first 4 kg leavening ferment A or B is mixed together with 4 kg wheat flour (type 550) and roughly 4 l water. The dough ferments for 6 hours at 22-24° C. “Anstellgut” can be taken off after 6 hours, which should then be stored in a cool environment until further use. The sponge dough is to be stored for roughly 6 hours in a cool environment, then processed within 36 hours. For the panettone dough 8 kg sponge dough, 6 kg wheat flour (type 550), 1.6 kg sugar, 1.6 kg eggs, 2.5 kg butter, 0.1 kg salt, 1.6 kg fruit (raisins, orange flavor, citrus flavor) are mixed together. Ideally one kneads the dough in a spiral kneader for 4+6 minutes. The dough temperature should be 28° C. The dough rests for 60 minutes and is then carefully weighed, lightly shaped into a round shape and placed in the panettone dish. The dough then ferments for 3-4 hours in the fermentation room at 30-32° C. When the dough has risen to ¾ in the dish, a cross shape is cut into it using scissors and the dish is placed into a preheated oven. The bake time is 50 minutes at a temperature decreasing from 200° C. to 180° C. Afterwards the panettone is coated with butter left to cool upside down.

### 6. Single-Stage Sponge Dough Propagation with Leavening Ferment A, B or D for Mild Rye Bread

For a total flour mass of 10 kg first 2.8 kg leavening ferment A or B is mixed together with 2.8 kg rye flour (type 997) and roughly 2.9 l water to prepare sponge dough. The dough temperature should be 20-24° C. The sponge dough is done after 6 hours and “Anstellgut” can be taken off, if so desired, which should then be stored in a cool environment until further use. The sponge dough should be processed within 24 hours.

For the bread dough 5.6 kg sponge dough, 7.2 kg rye flour (type 997), 5 l water and 0.2 kg salt are mixed together. Ideally one kneads the dough slowly for 6 minutes in a spiral kneader. The dough temperature should be 26-28° C. The dough rests for 60 minutes at 32° C. and is then separated into 850 g pieces and baked after 80-90 minutes fermentation at 32° C. The bake time is 40-50 minutes and bake temperature decreases from 250° C. to 210° C.

### 7. Single-Stage Sponge Dough Propagation with Leavening Ferment C for Gluten Free Baked Goods

40 g leavening ferment C is mixed together with 200 g rice flour and roughly 200 ml water and ferments for 15-18 minutes at 25-27° C. After 8 hours “Anstellgut” can be taken off from the ripe sponge dough. The dough is to be kept in a cool environment until further processing. For the gluten free bread dough 400 g sponge dough, 500 g teff flour, 250 g buckwheat flour, 250 g corn flour, 20 g salt, 30 g guar flour and 1100 ml water are mixed together. Ideally one kneads the dough for 5 minutes in a spiral kneader. The dough temperature should be 28° C. The dough rests for 10 minutes and is then weighted in boxes. The dough then ferments for 1.5-3 hours in the fermentation room at 30-32° C. The bake time is 60 minutes, the bake temperature 200° C.

### 8. Single-Stage Sponge Dough Propagation with Leavening Ferment A or B for Croissant Preparation

For a total flour mass of 10 kg first 4 kg leavening ferment A or B is mixed together with 4 kg wheat flour (type 550) and roughly 4 l water. The dough temperature should be 20-22° C. “Anstellgut” can be taken off after roughly 4-6 hours, which should then be stored in a cool environment until further use. For the croissant dough 8 kg sponge dough, 6 kg wheat flour (type 550), 0.5 kg sugar, 0.2 kg butter and roughly 1 l water as well as are mixed together. Ideally one kneads the dough in a spiral kneader for 2+5 minutes. The dough temperature should be 25-26° C. The dough is separated into 4 kg pieces (directly after kneading) and relaxes covered for 30 minutes in the cold room. After resting, 1 kg butter is incorporated into 4 kg dough and folded and laminated twice. Then the mixed dough is kept covered for 20 minutes in the cold room, laminated once again and then cooled again for 20 minutes. It is then processed as usual. Fermentation lasts for 2-3 hours at a maximum temperature of 28° C. The dough is baked for 15-20 minutes at 200° C. (loading oven).

### 9. Single-Stage Sponge Dough Propagation with Leavening Ferment A or B for Pandoro

For a total flour mass of 10 kg first 3 kg leavening ferment A or B is mixed together with 3 kg wheat flour (type 550) and roughly 3 l water. The dough ferments for 4-6 hours at 20-22° C. “Anstellgut” can be taken off from the ripe sponge dough after 6 hours, which should then be stored in a cool environment until further use. For the pandoro dough 6 kg sponge dough, 7 kg wheat flour (type 550), 2 kg sugar, 1.6 kg butter, 1.41 milk, 1.0 kg eggs, 0.8 kg egg yolk, salt, lemon peel and vanilla bean are mixed together. Ideally one kneads the dough in a spiral kneader for 4+6 minutes. The dough temperature should be 26-28° C. After a resting time of 60 minutes the dough is placed in the pandoro dish. The dough then ferments for 3-4 hours in the fermentation room at 30-32° C. The bake time is 60-75 minutes, the bake temperature is 180° C. After baking the pandoro is immediately taken out of the dish and dusted with powdered sugar.

1. Leavening ferment characterized in that
it is free of baker's yeast;
it contains a mixture of at least two pure cultured strains of lactic acid bacteria, whereby the pure strains are chosen from the group consisting of L. plantarum, L. pontis, sanfranciscensis, L. crispatus, L. suntoryeus, Le. argentinum, L. helveticus, L. paralimentarius, L. fermentum, L. paracasei, L. frumenti, L. alimentarius, W. cibaria, W. confusa, P. acidilactici, P. parvulus and P. pentosaceus, whereby at least one chosen pure strain is a strain of Pediococcus, and
it contains at least one cultured yeast strain, chosen from the group of strains consisting of C. humilis, C. milleri, S. exiguus, S. cerevisiae, S. minor, S. pastorianus and S. fructuum, whereby these yeasts have at no time point been grown or cultured on molasses.

2. The leavening ferment for manufacturing of baked goods according to claim 1 characterized in that when the sponge dough or dough is prepared in direct propagation and incubated for 5 to 24 hours the lactic acid content reaches a maximum value of 1%.

3. The leavening ferment for manufacturing of baked goods according to claim 1 characterized in that the sponge dough or dough is prepared in direct propagation and incubated for 5 to 24 hours wherein the fermentation quotient has a value of 1.0 to 10.

4. The leavening ferment for manufacturing of baked goods according to claim 1 characterized in that the sponge dough or dough prepared in direct propagation and incubated for 5 to 24 hours has a maltose content of 0.3 to 1.8%.

5. The leavening ferment for manufacturing of baked goods according to claim 1 characterized in that the manufactured sponge dough or dough after an incubation time of 5 to 24 hours has a CO₂ production rate of 70 to 300 ml/100 g flour.

6. Sourdough bread made with the leavening ferment according to claim 1 characterized in that the crust of the finished baked bread contains the flavor additive vanillin at a concentration greater than 1000 μg/kg dry mass.

7. Sourdough baked goods made with the leavening ferment according to claim 1 characterized in that the baked good or the bread has a maltose content of 0.3 to 1.8%.

8. A process for manufacturing baked goods from sourdough, characterized in that
in a first step flour is mixed with water and a leavening ferment and this mixture is incubated in direct propagation at 15° to 30° C.;
in a second step further baking ingredients and materials, wherein no baker's yeast or other leavening ingredients, is added, wherein the leavening ferment is free of baker's yeast and contains a mixture of at least two cultured pure strains of lactic acid bacteria chosen from the group consisting of L. plantarum, L. pontis, L. sanfranciscensis, L. crispatus, L. suntogeus, Le. argentinum, L. helveticus, L. paralimentarius, L. fermentum, L. paracasei, L. frumenti, L. alimentarius, W. cibaria, W. confusa, P. acidilactici, P. parvulus and P. pentosaceus, and contains at least one yeast strain chosen from the group of strains consisting of C. humilis, C. milleri, S. exiguus, S. cerevisiae, S. minor S. pastorianus and S. fructuum, whereby these yeasts have at no time point been grown or cultured on molasses;
the baked good is baked in a third step after a resting phase of 1 to 3 hours; and
the manufactured baked good has a lactic acid content of maximum 1%.

9. (canceled)

10. The process according to claim 8, whereby through use of leavening ferment in the sponge dough or dough preparation in direct propagation after 5 to 24 hours a fermentation quotient of 1.0 to 10 arises.

11. The process according to claim 8, whereby the sponge dough or dough after 16 to 24 hours incubation time has a CO₂ production rate of 70 to 300 ml per 100 g flour.

12. The process according to claim 8, whereby hydrolytic enzymes are added for intensification of the flavor development.

13. Sourdough bread made using the process according to claim 8, characterized in that the crust of the finished baked bread contains the flavor additive vanillin at a concentration of greater than 1000 mg/kg dry mass.

14. Sourdough baked goods made using the process according to claim 8, characterized in that the baked good or the bread has a maltose content of 0.3 to 1.8%.

15. (canceled)
